(19) United States
(12) Patent Application Publication
(10) Pub. No.: US 2013/0175414 A1
(43) Pub. Date: Jul. 11, 2013

(54) COLLAPSIBLE AND PORTABLE COMPOSITING APPARATUS

(71) Applicant: TRIAD SPORTS, INC. dba BOWNET, Camarillo, CA (US)

(72) Inventors: David NELSON, Camarillo, CA (US); John Robert LUCAS, Camarillo, CA (US)

(73) Assignee: TRIAD SPORTS, INC. dba BOWNET, Camarillo, CA (US)

(21) Appl. No.: 13/781,280

(22) Filed: Feb. 28, 2013

Related U.S. Application Data
(63) Continuation-in-part of application No. 13/485,775, filed on May 31, 2012.
(60) Provisional application No. 61/492,010, filed on Jun. 1, 2011.
(60) Provisional application No. 61/605,042, filed on Feb. 29, 2012.

(51) Int. Cl. F16M 11/00

(52) U.S. Cl. CPC F16M 11/00
USPC 248/158

(57) ABSTRACT

A compositing apparatus arranged to provide a compositing surface to be used in digital filming, recoding or photographing a subject against the compositing surface, that is easy to setup and is collapsible such that the compositing apparatus can be easily assembled by a single individual. The compositing apparatus comprises a base structure including a first and second support portion, a first and second base extension, and a hinge, wherein the first and second support portions are coupled to the respective base extension and the hinge. At least one rod is removably coupled to the base structure and received by a screen, wherein the screen is adapted to exert a force on the at least one rod causing the at least one rod to exert a force onto said hinge in order to lock the first and second support portions.

### RELATED APPLICATION

This application is a continuation in part application of Ser. No. 13/485,775 to David Nelson et al., filed on May 31, 2012, which claims the benefit of priority of U.S. Provisional Application Ser. No. 61/492,010, filed on Jun. 1, 2011. This application also claims the benefit of priority of U.S. Provisional Application Ser. No. 61/605,042, filed on Feb. 29, 2012. The contents of Ser. Nos. 13/485,775, 61/492,010, and 61/605,042, including their drawings, schematics, diagrams and written description, are hereby incorporated in their entirety by reference.

### BACKGROUND OF THE INVENTION

1. Field of the Invention

This invention relates to a compositing apparatus adapted to be used in combining visual elements from separate sources into single images. More specifically, the invention is directed to a compositing apparatus that is configured to be collapsible to allow for ease of portability, transport and assembly.

2. Description of the Related Art

Compositing is a technique used in film, video and still photography for replacing selected parts of an image with other material, such as another image or video stream, based on color hues or chroma range. The technique has been used heavily in many fields to remove a background from the subject of a photo or video and replaced with a different background. This is most commonly used to replace a colored background with a different setting. In the digital method of compositing, software commands designate a narrowly defined color as the part of an image to be replaced. Then every pixel within the designated color range is replaced by the software with a pixel from another image, aligned to appear as part of the original. For example, a TV weather person is recorded in front of a plain blue or green screen, while compositing software replaces only the designated blue or green color with weather maps.

The compositing technique is commonly used in video production and post-production. Compositing can be done with backgrounds of any color that are uniform and distinct, but green and blue backgrounds tend to be the most commonly used colors because their hue differs distinctly the most from human skin color. Compositing is used in the entertainment industry for adding special effects into a digital stream of images or video. However, commercially available software makes it possible for consumers to create videos using the compositing function with greenscreen or bluescreen kits.

Existing compositing devices include a colored backdrop attached to a bar frame at one end and rigid support frames attached to the bar frame so that the colored backdrop hangs from the bar frame like a curtain or drapery. The length of colored backdrop can allow the backdrop to lay on the ground so that person or subject can be placed on and in front of the backdrop.

A disadvantage of such devices is that the backdrop is only attached to the bar frame and not the rigid support frames such that the backdrop can be easily moved and is not firmly held in place by the rigid support frames. This could cause the backdrop to flap due to wind or have folds, wrinkles or non-uniform surface which can negatively affect the performance of the backdrop. Also, the rigid support frames are typically formed of rigid and heavy material that makes portability of the device difficult. Also, these devices cannot be easily collapsed and efficiently stored, and could also take a long time to assemble and/or disassemble.

There are portable compositing devices available, and they tend to have members that are formed from a single continuous piece or formed from numerous smaller pieces. A disadvantage of compositing devices formed of a single continuous piece is that they cannot be easily collapsed and efficiently stored due in part to its size. For example, a compositing device can be formed of a single continuous frame wherein wheels are attached to a base to allow the compositing device to be transported or wheeled out to a desired location. Although portable, transporting or positioning the compositing device can be cumbersome.

Portable compositing devices formed of numerous pieces are more likely to be collapsible and easier to transport, but have the distinct disadvantage of being difficult and slow to set up. For instance, loose fasteners may require tools for driving or tightening, and may also become lost in transit or storage or during assembly of the compositing device. Collapsible compositing devices may have components that are attached using lockable hinges. The hinges on such compositing devices typically require a locking device to hold the frame of the compositing device in a stable and locked position. Operation of the locking device of a typical hinge normally requires a person to press a button or release/attach a clip to collapse or deploy the compositing device. Pressing the button or releasing/attaching the clip could cause injury to a person, even if performed with care. Furthermore, if such locking device were to malfunction or break, the hinge would be ineffective at holding the support frame of the compositing device, thereby rendering the device inoperable.

In other conventional compositing devices, the colored backdrop or screen may be arranged to be attached to the frame on multiple side so that the colored backdrop can be taut; however, doing so could require the colored backdrop to have eyelets or openings all around the edges of the backdrop so that a rope, bungee cord, zip tie or the like can be inserted in the eyelets to attach the colored backdrop to the frame. Attaching the colored backdrop to the frame could take a long time and may not be easily completed. Furthermore, disassembly would be cumbersome because of having to remove the rope, bungee cord, zip ties or the like from the eyelets.

Conventional portable compositing devices when utilized in a windy environment or if struck by a projectile, can be easily knocked over and/or collapsed by the windy environment. This is due to the colored backdrop of the compositing device acting as a sail and/or the base structure not adapted to withstand the force applied by the wind and/or the projectile. The support frame for these colored backdrops are typically a tripod or a base that contacts the ground, and they do not provide sufficient stability so that the support frame can withstand the force of wind or the projectile and prevent the compositing device from falling over.

### SUMMARY

The invention disclosed herein provides various embodiments of a compositing apparatus that is cost effective, easy to assemble/disassemble, easily transportable and provides the required structural support to ensure that the compositing apparatus is maintained in an upright position. The different embodiments comprise elements to allow for the compositing apparatus to be collapsible, easy to transport between locations and yet provide a sufficiently sized colored backdrop to allow for filming or photographing of a subject against the colored backdrop. The invention is also configured such that the compositing apparatus can be easily assembled or disassembled by a single individual.

In one embodiment, as broadly described herein, a compositing apparatus comprises a base structure including a first support portion coupled to a hinge, a second support portion coupled to the hinge opposite the first support portion, a first rod and a second rod removably coupled to the base structure and received by a screen, wherein the hinge is configured to receive the first and second support portion such that the first and second support portion are adapted to rotate about a respective pivot point.

In another embodiment, a compositing apparatus comprises a base structure including first and second support portions pivotally attached to a hinge, first and second base extensions respectively coupled to the first and second support portions, a plurality of rods removably coupled to the base structure, and a colored backdrop adapted to receive at least part of at least one of the plurality of rods, such that the colored backdrop forms a compositing surface. The base structure, rods, hinge and colored backdrop, when fully deployed, are preferably adapted to maintain the compositing apparatus in an upright position.

These and other aspects and advantages of the invention will become apparent from the following detailed description and the accompanying drawings which illustrate by way of example the features of the invention.

### BRIEF DESCRIPTION OF THE DRAWINGS

FIG. 1a is a perspective view of a compositing apparatus according to an embodiment of the invention;

FIG. 1b is a perspective view of a base structure of the compositing apparatus of FIG. 1a;

FIG. 2a is a side view of a hinge of the compositing apparatus of FIG. 1a;

FIG. 2b is a side view of the hinge of the compositing apparatus of FIG. 1a;

FIG. 2c is a side view of the hinge of the compositing apparatus of FIG. 1a;

FIG. 3 is a partial perspective view of a compositing apparatus according to an embodiment of the invention;

FIG. 4 is a perspective view of a compositing apparatus according to an embodiment of the invention.

### DETAILED DESCRIPTION

The invention described herein is directed to different embodiments of compositing apparatuses that in some embodiments provide a frame structure that is easy to setup and is collapsible such that the frame structure is easy to assemble by a single individual, store and is portable. The compositing apparatus can comprise many different materials and can be used in many different applications such as, but not limited to, digitally filming and/or digitally photographing subjects against a colored backdrop, or in post-production of digital content. The compositing apparatus according to the present invention can be arranged in many different ways with many different components, and is generally arranged to provide a portable colored backdrop.

In one embodiment, a compositing apparatus comprises a base structure including at least one support portion and at least one base extension coupled to the at least one support portion. The compositing apparatus further comprises a hinge, wherein the at least one support portion is coupled to the hinge. At least one rod is removably coupled to the base structure and is adapted to be received by a screen. The screen is adapted to exert a pulling force on the at least one rod causing the at least one rod to exert a force onto said hinge, whereby the at least one support portion is locked into place.

In other embodiments, a compositing apparatus comprises a base structure including a first support portion and a second support portion, wherein the first and second support portions are coupled to a hinge, such that the first and second support portions are opposite each other and the hinge is interposed therebetween. First and second rods are removably coupled to the base structure, wherein the first rod is opposite the second rod, and a screen adapted to receive the first and second rod. The compositing apparatus can further comprise a first base extension coupled to the first support portion and a second base extension coupled to the second support portion. The base extensions are adapted to further support the load of the compositing apparatus and allow the compositing apparatus to remain upright while in use. In some embodiments, the compositing apparatus can also comprise an attachment device proximate the base structure, such that the attachment device is adapted to receive an attachment cord that is adapted to receive a weighted device or force resistance device to provide additional structural support. The compositing apparatus is advantageously configured to exert a force on the hinge in order to maintain the compositing apparatus in an upright position when deployed. This arrangement allows the hinge to remain in a fixed state without the need of one or more locking devices to lock the support portion to the hinge.

The invention can provide a number of additional advantages beyond those mentioned above. For example, the hinge allows for ease of assembly/disassembly and storage of the compositing apparatus because the hinge does not have a locking device that needs to be forcibly engaged and/or disengaged. Typical hinges have a locking pin that prevents an element from pivoting about the hinge. These locking pins can be hard to engage and/or disengage which could cause injury to the person trying to engage and/or disengage the locking pin. Other typical hinges have a locking button, instead of a locking pin, that is depressed in order to allow an element to be engaged and/or disengaged from the hinge. In such hinges, operation of the locking button requires the person to press down and pivot the element about the hinge. In some instances, the person pressing the locking button could get a portion of their finger, for example, caught and/or pinched by the button and causing injury. Another advantage of the invention is that the compositing apparatus is collapsible such that the compositing apparatus can be folded upon itself and form a smaller package that can easily be transported and/or stored without taking up too much physical space. A disadvantage of conventional hinges having the locking pin or the locking button is that the locking pin/button will deteriorate over time due to many different factors, such as the load imparted onto them or by damage due to repeated use or misuse.

Some embodiments of the compositing apparatus according to the invention can be used as providing a colored backdrop for digitally filming/photographing a subject against the colored backdrop. However, the invention is not intended to be limited to such embodiments. As further described below, the compositing apparatus can be arranged to allow an individual to easily deploy and disassemble the compositing apparatus in an outdoor and/or indoor setting.

The invention is described herein with reference to certain embodiments, but it is understood that the invention can be embodied in many different forms and should not be construed as limited to the embodiments set forth herein. In particular, the present invention is described below in regards to a compositing apparatus, but it is understood that the invention can be used for many other applications in many different settings. The components of the compositing apparatus can have different shapes and sizes beyond those shown in the figures or discussed herein.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the device in addition to the orientation depicted in the figures.

Embodiments of the invention are described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the invention.

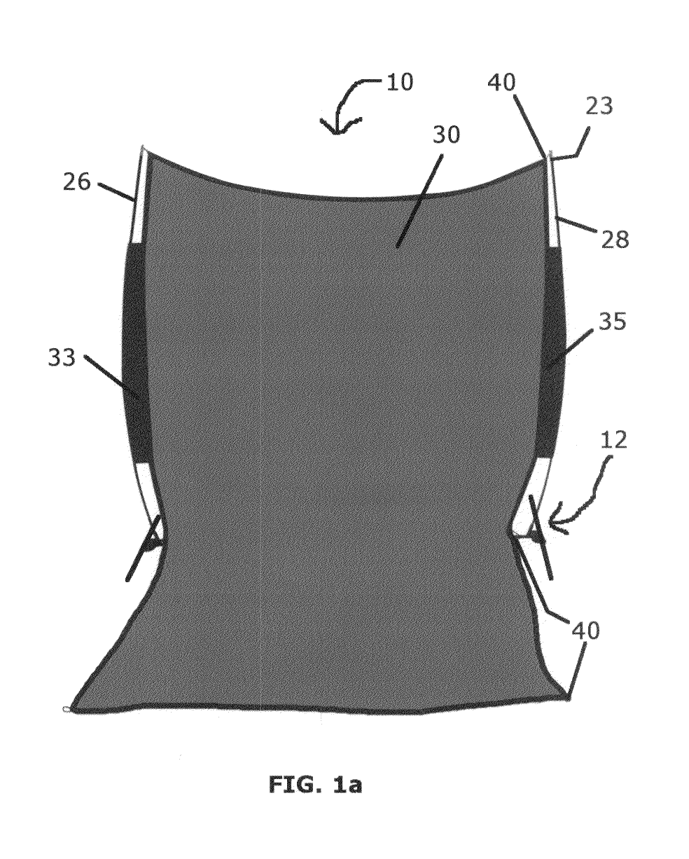

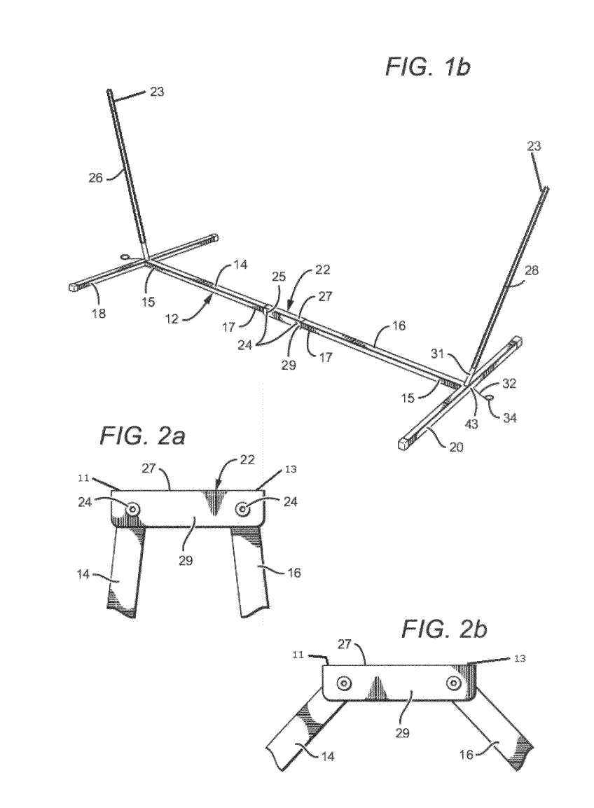

FIGS. 1a-2c disclose an embodiment of a compositing apparatus 10 according to an embodiment of the invention. The compositing apparatus 10 is configured such that the compositing apparatus 10 can be deployed in an outdoor setting such as, but not limited to, a natural grass, synthetic field, dirt, concrete or the like. The compositing apparatus 10 can also be deployed in an indoor setting such as but not limited to an indoor studio, residential or commercial setting having a synthetic or natural surface, or the like. The compositing apparatus 10 can be used in digital photographic and/or digital filming related activities, such as but not limited to live video transmission, post-production processing, inserting special effects (i.e. computer generated imagery), still photography and the like. The compositing apparatus 10 comprises a base structure 12 including first and second support portions 14, 16 pivotally attached to a hinge 22, a first and second rod 26, 28 removably coupled to the base structure 12, and a screen 30 adapted to receive the first and second rods 26, 28. The embodiment shown in FIGS. 1a-1b has two rods 26, 28, but other embodiments can have more than two rods. The first and second rods 26, 28 are configured to exert a force on the hinge 22 in order to lock the first and second support portions 14, 16 in place and prevent rotation of the first and second portions 14, 16 about the hinge 22. The base structure 12, first and second rods 26, 28 and screen 30, when fully assembled and deployed, are adapted to maintain the compositing apparatus 10 is an upright position. In some embodiments, the compositing apparatus 10 can be arranged to provide sufficient stability and withstand the force of a projectile and/or environmental conditions to prevent the compositing apparatus from falling over.

For the same or similar elements or features, the reference numbers from FIGS. 1a-2c will be used throughout the application herein. In one embodiment of the invention, the base structure 12 can further comprise a first base extension 18 coupled to the first support portion 14, and a second base extension 20 coupled to the second support portion 16. This arrangement allows the first and second base extensions 18, 20 to provide additional structural support to further stabilize the compositing apparatus 10 in an upright position. As shown in FIGS. 1a-1b, the first and second base extensions 18, 20 can be coupled to the respective support portions 14, 16 such that the first and second base extensions 18, 20 are substantially perpendicular to the respective support portion 14, 16. When the compositing apparatus 10 is placed on a substantially flat surface the support portions 14, 16 and the base extensions 18, 20 are in substantial contact with the flat surface.

The first and second support portions 14, 16 each have a first end 15 and a second end 17, wherein the first end 15 of each of the support portions 14, 16 is coupled to the respective base extensions 18, 20. The first and second support portions 14, 16 extend from the respective base extensions 18, 20 towards a hinge 22 and are pivotally coupled to the hinge 22, such that the base extensions 18, 20 are opposite the hinge 22. The second ends 17 of support portions 14, 16 are coupled to the hinge 22 using hinge pins 24. The hinge 22 has openings 25 that receive the hinge pins 24 so as to couple the support portions 14, 16 to the hinge 22. In one embodiment, the hinge pins 24 can be screws with a nut to hold the screw in place. However, in other embodiments, the openings 25 of the hinge 22 can be threaded to receive the hinge pins 24, or the hinge pins can be nails, rivets or the like. The support portions 14, 16 can be coupled to the hinge 22 using various known means in the art and is not intended to be limited to the embodiments disclosed herein. The first and second support portions 14, 16 can be made of many different materials, such as but not limited to wood, plastic, metal, a composition thereof or the like. The first and second support portions 14, 16 can be formed to have many different shapes, such as but not limited to circular, square, polygonal, a combination thereof or the like. The first and second portions 14, 16 of the embodiment of FIGS. 1-2c are shown as having a square-like shape, but the invention is not intended to be limited to such shapes.

The hinge 22 is arranged to receive at least a portion of the first and second support portions 14, 16 such that the support portions 14, 16 are able to pivot about their respective hinge pin 24; the hinge pin 24 thereby defining a respective pivot point for the support portion 14, 16. In one embodiment, the hinge 22 is configured to be a U-shaped channel having a hinge base 27, sidewalls 29 and openings 25 in the sidewalls 29 to allow respective hinge pins 24 to be received by the hinge 22 as well as the first and second support portions 14, 16, in order to pivotally couple the support portions 14, 16 to the hinge 22. In the embodiment of FIGS. 1a-1b, the second ends 17 of each of the first and second support portions 14, 16 are pivotally coupled to the hinge 22. However, in other embodiments, the first and second support portions 14, 16 can be pivotally coupled to the hinge 22 at different locations between the first and second ends 15, 17.

An advantage of the invention is that in some embodiments the hinge 22 can be U-shaped which allows the hinge to hold the first and second support portions 14, 16 in a stable and parallel position along the same axis. Another advantage is that the hinge base 27 provides a physical stop 11, for each support portion 14, 16 which prevents the support portions 14, 16 from rotating beyond the respective physical stop 11, 13. The support portions 14, 16 are axially aligned when the support portions 14, 16 are in contact with or substantially adjacent their respective physical stop 11, 13. The hinge 22 simplifies assembly of the invention because the hinge base 27 prevents the first and second support portions 14, from pivoting beyond the physical stop 11, 13. In the embodiment of FIGS. 1a-1b, the range of rotation of the support portions 14, 16 can be 0-180 degrees. However, in other embodiments, the support portions can have a range of rotation that is higher or lower than 0-180 degrees. The support portions 14, 16 are adapted to rotate about their respective hinge pin 24 towards the hinge base 27 in order to properly assemble the invention. However, in other embodiments, the hinge 22 can be arranged in many different configurations such that the support portions 14, 16 are not aligned along the same axis, can be parallel or non-parallel, yet still provide a physical stop to properly assemble the invention.

As shown in FIGS. 1a-2c, the first and second portions 14, 16 are coupled to the hinge 22, using hinge pins 24, such that they rotate about the respective hinge pin 24. Rotation of the first support portion 14, in a direction opposite the second support portion 16, about the hinge pin 24 will stop when the first support portion 14 comes into contact with the physical stop 11 of hinge base 27 of the hinge 22; FIG. 2c shows an example of the support portions 14, 16 in contact with the physical stops 11, 13 of the hinge base 27 and precluding further rotation. The hinge base 27 provides the physical stop and prevents the first support portion 14 from further rotation. The second support portion 16 is similarly configured as the first support portion 14 and will stop rotating about hinge pin 24 when the second support portion 16 contacts physical stop 13 of hinge base 27. The physical stops provided by the hinge 22 properly aligns the first and second support portions 14, 16 when assembling the compositing apparatus 10. Yet another advantage of the invention is that the hinge 22 allows the base structure 12 to be folded onto itself so that the compositing apparatus 10 can be easily stored as well as easy to transport. This arrangement allows the base structure to reduce its size and/or area, thereby allowing the compositing apparatus 10 to be stored in a small container.

When assembling the compositing apparatus 10, the first and second support portions 14, 16 of the base structure are rotated away from the opposite support portion 16, 14 towards the hinge base 27. When the support portions 14, 16 are in contact with the hinge base 27, precluding further rotation, the base structure 12 is ready to be placed on the surface, such as but not limited to a natural grass, synthetic filed, cement, wood, asphalt, or the like. The base structure 12 is placed on the surface such that the hinge base 27 is opposite the surface. In other words, the hinge base 27 does not contact the surface upon which the base structure 12 is disposed on. At this point, the first and second rods 26, 28 are ready to be installed.

The base structure 12 is further adapted to receive the first and second rods 26, 28. In one embodiment, the base structure 12 comprises at least one shaft 31 extending substantially vertically and configured to receive one of the first or second rod 26, 28. In the embodiment of FIGS. 1a-1b, the base structure 12 comprises two shafts 31, with one shaft 31 coupled to the first base extension 18 and another shaft 31 coupled to the second base extension 20. Each of the shafts 31 are coupled to a respective base extension 18, 20 proximate the first end 15 of the first and second support portions 14, 16. In other embodiments the base structure 12 can comprises a plurality of shafts 31, wherein each respective shaft 31 is adapted to receive a rod. In other embodiments, the shaft 31 can be positioned at various other locations on the base extensions 18, 20 and/or the support portions 14, 16, or a combination thereof. In yet other embodiments, the base structure 12 can comprise more than two shafts 31 for embodiments that comprise more than two rods 26. The number of rods utilized in a particular embodiment will require an equal amount of shafts 31 needed to receive the rods.

The rods 26, 28 are configured to be securely held within the shaft 31, such that the shaft 31 maintains a stable structural connection between the shaft 31 and the rods 26, 28 and prevents the rod 26 from being removed from the shaft 31 when the compositing apparatus 10 is assembled. In one embodiment of the invention, the shaft 31 is similarly shaped as the rods 26, 28, such as but not limited to cylindrically shaped, and is slightly larger than the rod 26 so that the rods 26, 28 can be easily received by the shaft 31. The shaft 31 can further comprise a sheath contacting the inner wall of the shaft 31 that receives the rod 26. The sheath is adapted to protect the rod 26 within the shaft 31 from forces exerted on the rod 26 when the compositing apparatus 10 is fully assembled. As will be discussed below, upon assembly of the compositing apparatus 10, the rods 26, 28 experience a moment force at the point where the rods 26, 28 are received by the shaft 31, and cause the rods 26, 28 to exert a compression force upon the sheath. The sheath thereby protects the rods 26, 28 from the forces exerted on and/or by the rod 26, 28.

In other embodiments, the shaft 31 can be shaped such that the radius of the shaft 31 decreases the further the rods 26, 28 are inserted into the shaft 31. In this arrangement, the shaft 31 uses a compression force to form the structural connection between the shaft 31 and the rods 26, 28. In other embodiments, mechanical devices, such as but not limited to, screws, nuts, nails, rivets or the like, can be used to form the structural connection so as to securely attach the rods 26, 28 to the shaft 31. In yet other embodiments, the rods 26, 28 can be configured to have an attachment means such that the rods 26, can be attached to the shaft 31; non-limiting examples of such attachment means are the rods 26, 28 being threaded and screwed into the shaft 31 or the rods 26, 28 and shaft 31 configured similarly like a bayonet-type locking device.

In the embodiment of FIGS. 1a-1b, the rods 26, 28 are circularly shaped and the opening of the shaft 31 is also correspondingly circularly shaped to receive the rods 26, 28. The shape of the rods 26, 28 and shaft 31 is not intended to be limited to a circular shape, other shapes such as quadrilateral, triangular, or any other polygonal shape can be used. In some embodiments, the shaft 31 can be shaped differently than the rods 26, 28. The rods 26, 28 can be made of many different materials known in the art, such as but not limited to fiberglass or carbon fiber, such that the rods 26, 28 are flexible, elastic, capable of returning to its initial form or state after deformation, and able to withstand the impact forces applied by projectiles and/or forces of nature that can be thrown, kicked, directed and/or hit towards the compositing apparatus 10.

The rods 26, 28 when received by the shaft 31 flare outwards in a direction opposite the hinge 22 in a relaxed state and substantially straight. The rods 26, 28 flare outwards when received by the shafts 31 due to the shaft 31 being disposed at an obtuse angle with respect to the respective support portions 14, 16. The shafts 31 being set at the obtuse angle require that the rods 26, 28 be bent in order to be received by the screen. When the rods 26, 28 are received by a screen 30, the rods 26, 28 are pulled in towards the hinge 22 and impart a force onto at least the first and second support portions 14, 16 which securely locks the base structure 12. The rods 26, 28 act in a manner similar to that of a cantilever, such that the rods 26, 28 are anchored at the end that is received by the shaft 31.

Screen 30 is arranged to receive rods 26, 28 and is adapted to exert a force on rods 26, 28 bending the rods 26, 28 into a flexed state. In one embodiment, the screen 30 comprises at least one sleeve 33 adapted to receive a respective one of the rods 26, 28. In the embodiment of FIGS. 1a-1b, the screen 30 comprises a first sleeve 33 and a second sleeve 35 opposite the first sleeve 33, wherein the first rod 26 is received by the first sleeve 33 and the second rod 28 is received by the second sleeve 35. The first and second sleeves 33, 35 are shown in FIG. 1a as being a single sleeve that extends along opposite edges of the screen 30, such that part of the rods 26, 28 are contained within the sleeves 33, 35. The sleeves 33, 35 can be arranged in many different configurations and is not intended to be limited to the embodiments disclosed herein. In other embodiments, one or both of the sleeves 33, 35 can be comprised of a plurality of sleeves that are disposed along an edge of the screen 30.

Inserting the rods 26, 28 into the respective sleeve 33, 35 requires that the rods 26, 28 be bent from the relaxed state into a flexed state to allow the sleeves 33, 35 to receive the respective rod 26, 28. As shown in the embodiment of the invention in FIGS. 1a-1b, when both rods 26, 28 are received by the respective shaft 31 and the screen 30, the screen imparts a pulling force on both rods 26, 28 which causes the rods 26, 28 to be bent in a direction towards the hinge 22 and into the flexed state. In the flexed state, the rods 26, 28 experience a moment force about their respective pivot point. The pivot point of each of the rods 26, 28 corresponds to the point at which the rods 26, 28 are received by the respective shaft 31. The moment force experienced by the rods 26 is imparted onto the hinge 22 and the first and second support portions 14, 16 of the base structure 12, with the transferred force being greatest at the hinge 22. This transferred force further assists in locking the hinge 22 and base structure 12, such that the first and second support portions 14, 16 are locked into place.

An advantage of the invention is that the force exerted onto the rods 26, 28 by the screen 30 results in a torque force experienced by the rods 26, 28 and transferred to the hinge 22, which allows the hinge 22 to lock the first and second support portions 14, 16 into place without the need of a locking device such as a locking clip or button. The absence of such a locking device on the hinge 22 prolongs the lifetime of the compositing apparatus 10 due, in part, to the hinge 22 not deteriorating or breaking down due to failure or malfunctioning of the locking clip or button.

Removal of the screen 30 by withdrawing the rods 26, 28 from the sleeves 33, 35 allows the rods 26, 28 to return to their original form of the relaxed state. The rods 26, 28 are sufficiently elastic such that repeated use of the compositing apparatus 10 does not result in the rods 26, 28 being permanently bent in a shape similar to that of the flexed state. The screen 30 can be easily installed and removed by a single individual.

The screen 30 can be a solid colored surface that can be used as a compositing screen. In some embodiments, the color of the screen can be green or blue. However, the color of the screen is not intended to be limited to green or blue. There are numerous variations of colors that can be used for the screen, such as but not limited to digital green, digital blue or any other color known in the art. However, in other embodiments the screen 30 can be a backdrop having a patterned design, natural landscape, or other scenery instead of being a solid colored surface. In such embodiments, the screen would not operate as a compositing screen, but instead would be a conventional backdrop that can be used in filming or photographing a subject against the backdrop.

The embodiment of FIG. 1a discloses the screen 30 as having sleeves 33, 35 in the form of a sleeve that extends along part of the screen 30 along opposite edges. However, in other embodiments, the sleeves can be arranged to comprise a plurality of loops that receive the rods 26, 28. In other embodiments, the screen 30 comprises a plurality of sleeves wherein at least one of the plurality of sleeves is adapted to receive the base structure 12 in order to secure the screen 30 to the base structure 12. This allows the screen to maintain a uniform layout and prevents the screen from becoming distorted, twisted or wrinkled which could cause shadows on the screen 30 and could cause the screen 30 to be an ineffective compositing screen. The sleeves 33, 35 can be configured in many different ways, such as but not limited to a sleeve that spans the length of the rods 26, 28, a plurality of smaller sleeves that are spaced apart from each other and run along the length of the rods 26, 28, or a sleeve that spans along a partial length of the rods 26, 28. In some embodiments, each rod 26, 28 comprises an endcap 23 opposite the portion of the rod that is received by the shaft 31 and is configured to receive part of the screen 30, such that the endcap 23 prevents the sleeves 33 from coming off the rods 26 while the compositing apparatus 10 is assembled and/or in use. As shown in FIG. 1a, the screen 30 comprises a plurality of loops or the like 40, wherein a loop 40 at the corners of the screen 30, proximate the rods 26, 28, are adapted to be received by a respective endcap 23. The endcaps 23 receiving the loops 40 at the corners of the screen 30 provide structural support for the screen 30 so that the screen 30 can be held to form a substantially flat surface. In one embodiment, the endcaps 23 can have a tab that extends outward beyond the external shape of the rod 26 that receives the loop 40 and prevents the screen 30 from coming off the rod. However, in other embodiments, the endcaps 23 can have other means of preventing the screen 30 from coming off the rod, such as but not limited to a hook, locking clip, or the like.

The base structure 12 further comprises a plurality of attachment devices 43 disposed at various locations on the support portions 14, 16 and/or base extensions 18, 20. In the embodiment of FIG. 1a, the screen 30 is configured to cover part of the surface upon which the compositing apparatus 10 is on, such that a subject to be filmed or photographed can be disposed on the screen 30. In such embodiments, the screen 30 comprises at least one loop 40 that can be coupled to the attachment device 43 of the base structure 12. The loop 40 and attachment device 43 cooperate to prevent the screen 30 from becoming distorted or deformed. In other embodiments, the screen can be arranged to only extend to the base structure 12 and not cover the surface, wherein at least one loop 40 can be coupled to the attachment device 43 of the base structure 12 to secure the screen 30 to the base structure 12 and form a substantially flat surface. As further seen in FIG. 1a, the portion of the screen that covers part of the surface or ground that the compositing apparatus 10 is disposed on also comprises loops 40 that can be used to secure the screen 30 to the surface. For example, a stake or weight can be attached to the loop 40 that is proximate the surface so as to secure the screen 30 to the surface and prevent the screen 30 from losing its shape and/or compositing properties.

In some embodiments of the invention, the compositing apparatus 10 can comprise at least one attachment device 43 that can receive an attachment cord 32 having a ring 34. The attachment cord 32 allows for the connection of a weight, stake or similar device to provide additional support for the compositing apparatus 10. The attachment device 43 can be configured to be a loop-like device that is coupled to the base structure 12 and allows the attachment cord 32 to be tied or coupled to the attachment device 43. The attachment cord 32 can be a bungee cord, rope, or the like. The ring 34 allows for a weighted or force-resistant device (not shown), such as but not limited to a sandbag or a suction cup, to be attached to the base structure 12 to provide additional support for the compositing apparatus 10 and prevent the compositing apparatus 10 from moving, falling over, or shifting. The ring 34 can also be used to receive a stake, staple, hook or similar device that is inserted into the ground or surface so as to attach the compositing apparatus 10 to the ground or surface.

The attachment device 43 is configured to extend laterally or horizontally from the base structure 12, such that the weight or similar device attached to the cord 32 provides a lateral support, which prevents the compositing apparatus 10 from lifting upwards or shifting its position. An advantage of this arrangement is that the weight or similar device attached to the attachment device 43 can also act as a shock absorber in the event that a projectile or forces of nature impart a shock force on the compositing apparatus 10. The shock force imparted on the compositing apparatus 10 is distributed throughout the compositing apparatus 10 and also partially transferred to the weight or device attached to the attachment device 43, which further provides additional support to the compositing apparatus which increases the stability and/or the force the compositing apparatus 10 can withstand. In other embodiments of the invention, the compositing apparatus 10 comprises a plurality of attachment devices 43 and can be disposed on the base structure 12 and/or on base extensions 18, 20.

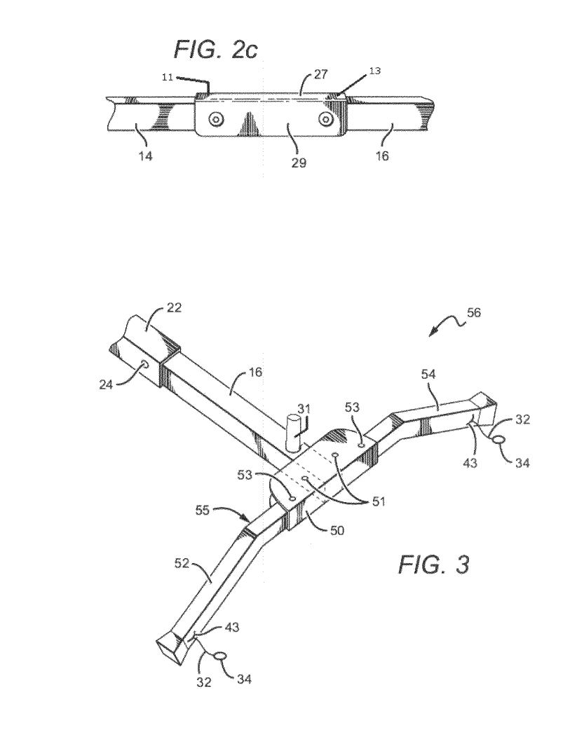

FIG. 3 discloses another embodiment of the invention, wherein a base extension 55 comprises a base extension hinge 50 coupled to the support portion 16, first and second base extension legs 52, 54 are pivotally attached to the base extension hinge 50 about a respective pivot point 51, wherein the legs 52, 54 are secured to the extension hinge 50 by a push-button extending into and received by hole 53 of the extension hinge 50. In this arrangement, the legs 52, 54 are able to rotate about pivot point 51 towards the support potion 16 such that the base structure 56 is further collapsible and easy to transport. The legs 52, 54 are arranged to be rotated towards the second portion 16 by releasing the push-button from the hole 53. The extension hinge 50 also provides a stop similar to the hinge 22 to prevent the legs 52, 54 from rotating beyond the hole 53. FIG. 3 only discloses the base extension 55 and base extension hinge 50 coupled to the second support portion 16; the first support portion 14 is also similarly configured to comprise a base extension 55 and base extension hinge 50 configured in a manner similar to second support portion 16. The first and second legs 52, 54 can be arranged in many different configurations, such as but not limited to being bent, curved, straight or a combination thereof, such that the base structure 56 is elevated off the ground or surface. However, in other embodiments, the legs 52, 54 can be arranged to allow the base structure 56 to contact the ground or surface. The legs 52, 54 can also comprise an attachment device 43, attachment cord 32 and ring 34 similar to the embodiment of FIGS. 1a-1b.

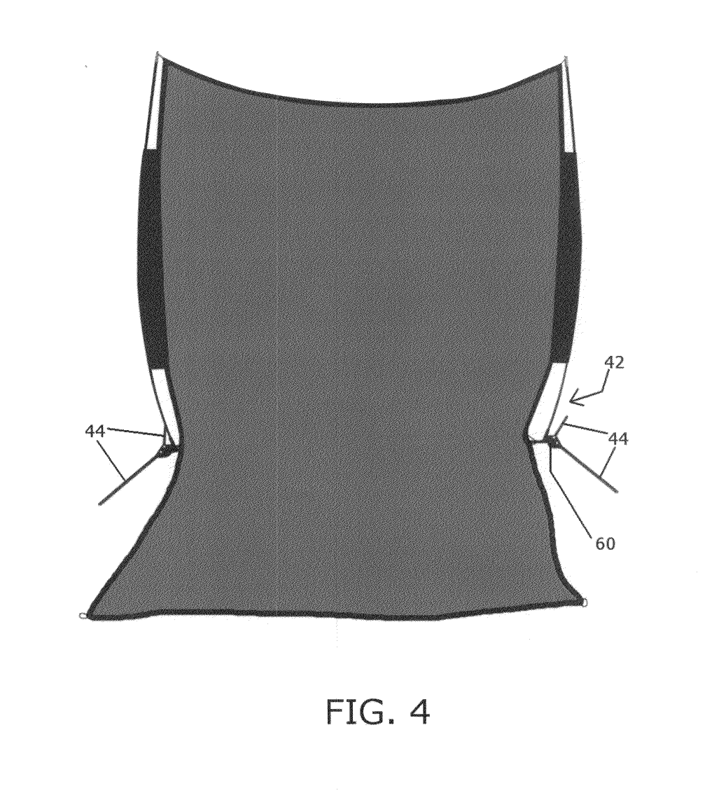

FIG. 4 discloses an embodiment wherein the first and second base extensions 44, 46 can be arranged in a V-shaped configuration. The first and second base extensions 44, 46 can be configured to raise the base structure 42 above the surface or can be configured to allow the base structure 42 to contact the surface. The base extensions 44, 46 are pivotally attached to a hinge 60, wherein the hinge 60 is arranged to align the base extensions 44, 46 in the V-shaped configuration. The angle of the V-shaped base extensions 44, 46 can be in the range of 90°-140° (degrees); however, the angular separation between the legs of the base extensions 44, 46 can be higher or lower.

Although the invention has been described in considerable detail with reference to certain configurations thereof, other versions are possible. Compositing apparatuses according to the invention can be many different sizes and can be used for many different applications, other than for providing a colored backdrop for digital filming or photography. The compositing apparatus can comprise screen sidewalls to provide additional colored backdrops, wherein each base extension comprises a plurality of shafts that receive a respective one of a plurality of rods. The compositing apparatus can also include a plurality of hinges that lock its base structure to the hinge using the force exerted onto the hinge from the frame structure of the compositing apparatus. In other embodiments, the support portions can be adjustable to make a smaller or bigger base structure, while the size of the rods can also be adjusted to make a smaller or bigger compositing apparatus. In other embodiments, the rods can be made of a single piece of material, whereas in other embodiments, the rods can be comprised of a plurality of rod pieces that are joined together to form the rod. Therefore, the spirit and scope of the invention should not be limited to the versions described above.

We claim:

1. A compositing apparatus, comprising:
a base structure including a first support portion coupled to a hinge and a second support portion coupled to said hinge opposite said first support portion;
a first rod and a second rod removably coupled to said base structure, said first rod opposite said second rod; and
a screen adapted to receive said first rod and said second rod;
said hinge configured to receive said first support portion and said second support portion, such that said first support portion and said second support portion are adapted to rotate about a respective pivot.

2. The compositing apparatus of claim 1, wherein said first and second support portions are pivotally coupled to said hinge at said respective pivot point.

3. The compositing apparatus of claim 1, said base structure further comprising a first base extension coupled to said first support portion and a second base extension coupled to said second support portion.

4. The compositing apparatus of claim 1, wherein said hinge is adapted to prevent rotation of said first and second support portions beyond a desired position.

5. The compositing apparatus of claim 4, wherein said hinge comprises a hinge base adapted to receive said first and second support portions and preclude rotation of said first and second support portions.

6. The compositing apparatus of claim 1, wherein said hinge is configured to axially align said first and second support portions when said compositing apparatus is fully assembled.

7. The compositing apparatus of claim 1, wherein said base structure further comprises at least one shaft adapted to receive one of said first or second rods.

8. The compositing apparatus of claim 7, wherein said base structure comprising a first shaft coupled to said first support portion and a second shaft coupled to said second support portion, wherein said first shaft receives said first rod and said second shaft receives said second rod.

9. The compositing apparatus of claim 1, said screen further comprising at least one sleeve configured to receive at least one of said first or second rods, such that said screen is adapted to exert a force onto said first and second rods to position said first and second rods into a flexed state.

10. The compositing apparatus of claim 9, wherein said screen comprises a first sleeve and a second sleeve opposite said first sleeve, wherein said first sleeve receives said first rod and said second sleeve receives said second rod.

11. The compositing apparatus of claim 10, wherein either of said first or second sleeves can be comprised of a plurality of sleeves.

12. The compositing apparatus of claim 1, wherein said first and second rods are adapted to exert a torque force to lock said first and second support portions.

13. The compositing apparatus of claim 12, wherein said torque force is exerted onto at least one of said hinge, said base structure, or a combination thereof.

14. A compositing apparatus, comprising:
a base structure comprising:
first and second support portions; and
first and second base extensions, said first base extension coupled to said first support portion and said second base extension coupled to said second support portion;
a hinge configured to receive said first and second support portions, such that said first and second support portions are pivotally attached to said hinge;
a first and second rod removably coupled to said base structure; and
a colored backdrop adapted to receive at least part of one of said first and second rods, such that said colored backdrop forms a compositing surface.

15. The compositing apparatus of claim 14, wherein said first and second base extensions can be straight, angled, or a combination thereof.

16. The compositing apparatus of claim 14, said hinge further comprising a hinge base and a plurality of sidewalls, wherein said hinge base is adapted to prevent rotation of said first and second support portions beyond a range of rotation.

17. The compositing apparatus of claim 16, wherein said hinge is configured to align said first and second support portions about the same axis.

18. The compositing apparatus of claim 14, said screen further comprising a sleeve configured to receive said at least one rod, said screen adapted to exert a force onto said at least one rod to position said at least one rod into a flexed state.

19. The compositing apparatus of claim 14, wherein said base structure further comprises a first shaft and a second shaft each coupled to said base structure, said first shaft adapted to receive said first rod and said second shaft adapted to receive said second rod.

20. The compositing apparatus of claim 14, wherein said first and second rods are adapted to exert a torque force to lock at least one of said first or second support portions, wherein said torque force is exerted onto at least one of said hinge, said base structure, or a combination thereof.
